(19) United States
(12) Patent Application Publication
(10) Pub. No.: US 2015/0051913 A1
(43) Pub. Date: Feb. 19, 2015

(54) UNLOCK METHOD USING NATURAL LANGUAGE PROCESSING AND TERMINAL FOR PERFORMING SAME

(71) Applicant: Seheon Choi, Seoul (KR)

(72) Inventor: Seheon Choi, Seoul (KR)

(73) Assignee: LG ELECTRONICS INC., Seoul (KR)

(21) Appl. No.: 14/384,068

(22) PCT Filed: Mar. 16, 2012
(86) PCT No.: PCT/KR2012/001899

§ 371 Date: Sep. 9, 2014

(51) Int. Cl. G10L 15/22

(52) U.S. Cl. CPC G10L 15/22; G10L 2015/223
USPC 704/273

(57) ABSTRACT

The present description relates to an unlock method and to a terminal for performing same, the unlock method being performed by a terminal that provides a lock function, the unlock method comprising: a step of displaying a voice input screen on a lock screen of the terminal; a step of taking, as an input, voice from a user; a step of performing natural language processing on the voice to acquire an object constituting the voice; a step of determining whether or not the object contains a passphrase for unlocking; and a step of unlocking the terminal or maintaining the terminal in the locked state depending on the result of the determination of whether the object contains the passphrase.

### TECHNICAL FIELD

The present disclosure relates to an unlock implementation method using natural language processing (NLP) and a terminal using the same.

### BACKGROUND ART

In recent years, with the enhancement of data storage and sharing functions of a terminal, recognition for security of a personal terminal has been enhanced. Accordingly, examples that employ a screen lock function (or lock function) on the terminal have been increased.

A screen lock function does not allow a user to use various functions of a terminal in a state that the screen lock is not released. In other words, the user can use various functions of a terminal subsequent to releasing the screen lock or use only some functions in a screen lock state, such as a notification function, weather, playing music and the like.

In order to release a screen lock function, a user should click a release button or enter a predetermined password or pattern through a touch of the display unit, thereby ensuring the security of a terminal. In recent years, technologies for sensing a user's gesture to release screen lock have attracted attention.

However, the release of screen lock using a touch or gesture sensing technology may be also carried out by another user who knows a pattern or gesture for releasing screen lock, and even in the event of theft of a terminal, the password or pattern may be also released when it is identical to a result obtained through an attempt based on various combinations.

Furthermore, the release of screen lock with one password, pattern or gesture has a high level of security enhancement, and thus when a user forgets his or her password, pattern or gesture, he or she may be unable to perform unlock, thereby disallowing flexible applications to security.

### DISCLOSURE OF THE INVENTION

An aspect of the present disclosure is to provide an unlock implementation method using natural language processing (NLP) based on voice received from a user and a terminal using the same.

In addition, another aspect of the present disclosure is to provide an unlock implementation method using natural language processing (NLP) for sensing a state of terminal theft to generate an alarm, and performing natural language processing based on voice received from a user to determine whether or not to release the theft alarm, and a terminal using the same.

An unlock implementation method of a terminal providing a lock function disclosed in the present disclosure may include displaying a voice input screen on a lock screen of the terminal, receiving voice from a user, processing the voice in a natural language processing scheme to acquire an object constituting the voice, determining whether or not the object contains a passphrase for releasing a lock state, and releasing or maintaining the lock state of the terminal according to the determination result on whether or not the object contains the passphrase.

Furthermore, the voice input screen may be displayed on the lock screen in the form of at least one of an icon, a notification message, and a popup message.

Furthermore, the object constituting the voice may be at least one of a sentence, a word and a vocabulary.

Furthermore, the passphrase may be a sentence or word which is the same as or similar to any one of one or more passphrases constituting a passphrase set, wherein the passphrase set includes at least one passphrase which is preset to authenticate a user who is allowed to release a lock state.

Furthermore, said releasing or maintaining a lock state may include determining whether or not the object contains an execution command of a function provided by the terminal when the object contains the passphrase, and releasing the lock state and performing the function when containing the execution command, and releasing the lock state when not containing the execution command.

Furthermore, said releasing or maintaining the lock state may include determining whether or not the object contains an execution command of a function that does not require the release of the lock state when the object does not contain the passphrase, and performing the function without releasing the lock state based on a result of the determination on whether or not containing the execution command.

Furthermore, the method may further include displaying a notification for requesting lock state release to a user based on a result of the determination on whether or not the object contains the execution command.

Furthermore, said displaying a voice input screen may include sensing whether or not a theft of the terminal has occurred, and setting a theft status of the terminal to a theft assumption state based on the sensing result, and displaying the voice input screen on the lock screen.

Furthermore, said releasing or maintaining the lock state of the terminal may include releasing the lock state and setting the theft status to a theft release state when the object contains the passphrase, and setting the theft status to a theft confirmation state without releasing the lock state when the object does not contain the passphrase.

Furthermore, the method may further include performing at least one of the operations of alarm warning, transmitting a current location of the terminal to another terminal, deleting specific information stored in the terminal, and theft report when the object does not contain the passphrase.

Furthermore, a terminal providing a lock function disclosed in the present disclosure may include a display unit configured to display a voice input screen on a lock screen of the terminal, an input unit configured to receive voice from a user, and a controller configured to process the voice in a natural language processing scheme to acquire an object constituting the voice, wherein the controller determines whether or not the object contains a passphrase for releasing a lock state, and releases or maintains the lock state of the terminal according to the determination result on whether or not the object contains the passphrase.

The terminal may further include a storage unit configured to store a passphrase set comprising at least one passphrase which is preset to authenticate a user who is allowed to release a lock state, wherein the passphrase is a sentence or word which is the same as or similar to any one of one or more passphrases constituting the passphrase set.

Furthermore, the controller may determine whether or not the object contains an execution command of a function provided by the terminal when the object contains the passphrase, and release a lock state and perform the function when containing the execution command, and release the lock state when not containing the execution command.

Furthermore, the controller may determine whether or not the object contains an execution command of a function that does not require the release of the lock state when the object does not contain the passphrase, and perform the function without releasing the lock state based on a result of the determination on whether or not containing the execution command.

The terminal may further include a senor unit configured to sense whether or not a theft of the terminal has occurred, wherein the controller sets a theft status of the terminal to a theft assumption state based on the sensing result of the sensor unit, and controls the display unit to display the voice input screen on the lock screen.

Furthermore, the controller may release a lock state and set the theft status to a theft release state when the object contains the passphrase, and set the theft status to a theft confirmation state without releasing the lock state when the object does not contain the passphrase.

Furthermore, the controller may perform at least one of the operations of alarm warning, transmitting a current location of the terminal to another terminal, deleting specific information stored in the terminal, and theft report when the object does not contain the passphrase.

According to an unlock implementation method using NLP and a terminal using the same method disclosed in the present disclosure, natural language processing may be carried out based on an input voice, and unlock may be determined by comparing it with a passphrase set formed based on vocabularies repeatedly used by a user, thereby providing the security of the terminal having a more efficient unlock function than that in the related art, as well as having more flexibility than a case of using one passphrase.

Furthermore, according to an unlock implementation method using NLP and a terminal using the same method disclosed in the present disclosure, various functions of the terminal may be immediately carried out while at the same time unlocking through natural language processing, thereby increasing the use facilitation of the terminal.

In addition, according to an unlock implementation method using NLP and a terminal using the same method disclosed in the present disclosure, a theft status of the terminal may be sensed to generate a theft alarm, and whether or not to release the theft alarm may be determined according to a passphrase set formed based on vocabularies repeatedly used by a user through natural language processing, thereby enhancing a security function in the event of theft.

### BRIEF DESCRIPTION OF THE DRAWINGS

FIG. 1 is a block diagram illustrating the structure of a terminal implementing a method according to embodiments disclosed in the present disclosure.

FIG. 2 is a flow chart schematically illustrating an unlock implementation method according to a first embodiment disclosed in the present disclosure.

FIGS. 3A through 3C are views illustrating an example in which a terminal according to a first embodiment disclosed in the present disclosure displays a voice input screen.

FIG. 4 is a flow chart specifically illustrating an unlock implementation method according to a first embodiment disclosed in the present disclosure.

FIG. 5 is a view illustrating an example in which a terminal implementing a first embodiment disclosed in the present disclosure performs a specific function while at the same time releasing a lock state.

FIG. 6 is a view illustrating an example in which a terminal implementing a first embodiment disclosed in the present disclosure displays a notification message for requesting unlock.

FIGS. 7A and 7B are views illustrating an example in which a terminal implementing a first embodiment disclosed in the present disclosure performs a specific function without releasing a lock state.

FIG. 8 is a flow chart illustrating an unlock implementation method according to a second embodiment disclosed in the present disclosure.

FIG. 9 is a view illustrating an example in which a terminal implementing a second embodiment disclosed in the present disclosure displays a message indicating that a theft state has been sensed.

FIGS. 10A and 10B are views illustrating an example in which a terminal implementing a second embodiment disclosed in the present disclosure performs a specific function corresponding to the event of theft.

### MODES FOR CARRYING OUT THE PREFERRED EMBODIMENTS

Technologies disclosed in the present disclosure may be applicable to a terminal providing a lock function. However, technologies disclosed in the present disclosure may not be necessarily limited to this, and may be also applicable to all image display devices, multimedia devices, equipments, and control methods thereof to which the technical concept of the technologies is applicable.

For example, technologies disclosed in the present disclosure may be applicable to various terminals such as a smart phone, a portable terminal, a mobile terminal, a personal digital assistant (PDA), a portable multimedia player (PMP) terminal, a laptop computer, a Wibro terminal, an internet protocol television (IPTV) terminal, a digital broadcast terminal, a telematics terminal, a navigation terminal, an audio video navigation (AVN) terminal, a television, a 3D television, an audio/video (NV) system, a home theatre system, an information providing center, a call center, and the like.

The lock function refers to a function for disallowing a terminal to perform an operation corresponding to an input event even when the input event, such as a button input, a touch input, gesture recognition, voice recognition or the like, is generated from the outside according to the setting status. In other words, a terminal set to a lock function does not perform an operation corresponding to an input event even when the input event is generated from the outside. On the contrary, when the lock function is released, the terminal performs an operation corresponding to the input event.

According to an embodiment disclosed in the present disclosure, a terminal may sense voice received from a user, and process the voice in a natural language processing scheme to change the setting status of a lock function.

A state set to the lock function may be substituted by terms such as a lock state, a screen lock, an inactive state, a state in which a standby screen is displayed, a standby mode, a security setting state, and the like, according to circumstances.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the concept of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

Furthermore, in the present disclosure, the terms including an ordinal number such as first, second, etc. can be used to describe various elements, but the elements should not be limited by those terms. The terms are used merely for the purpose to distinguish an element from the other element. For example, a first element may be named to a second element, and similarly, a second element may be named to a first element without departing from the scope of right of the invention.

Hereinafter, the embodiments disclosed herein will be described in detail with reference to the accompanying drawings, and the same or similar elements are designated with the same numeral references regardless of the numerals in the drawings and their redundant description will be omitted.

In describing the present disclosure, moreover, the detailed description will be omitted when a specific description for publicly known technologies to which the invention pertains is judged to obscure the gist of the present invention. Also, it should be noted that the accompanying drawings are merely illustrated to easily explain the concept of the invention, and therefore, they should not be construed to limit the technological concept disclosed herein by the accompanying drawings.

Furthermore, each embodiment will be described by taking a portable terminal as a representative example, but it should be noted that technologies disclosed in the present disclosure are applicable to various electronic devices providing a lock function as well as a portable terminal.

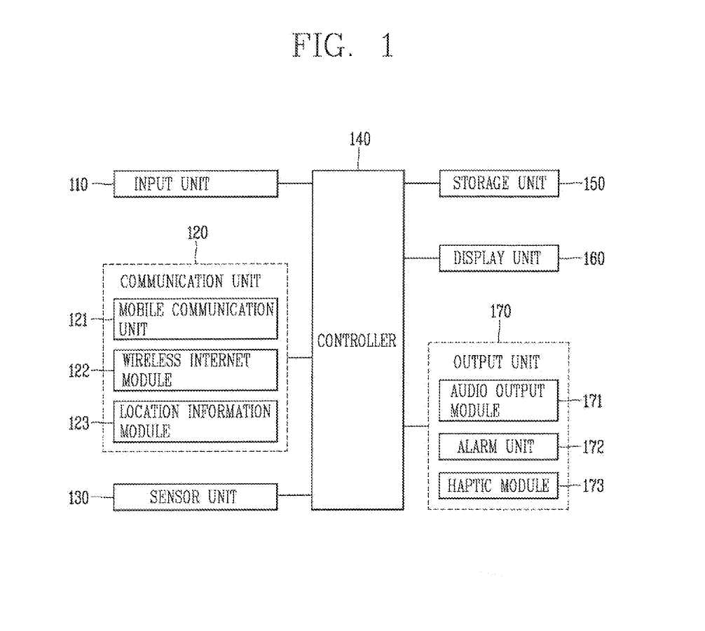

FIG. 1 is a block diagram illustrating the structure of a terminal implementing a method according to embodiments disclosed in the present disclosure.

Referring to FIG. 1, the terminal 100 may include an input unit 110, a communication unit 120, a sensor unit 130, a controller 140, a storage unit 150, a display unit 160 and an output unit 170.

The input unit 110 generates input data for the operation control of a terminal.

For example, the input unit 110 may be configured with a keypad, a dome switch, a touch pad (resistive/capacitive), a jog wheel, a jog switch, and the like.

Furthermore, the input unit 110 may include a camera, a microphone or the like for an audio signal or video signal input.

The camera processes image frames such as still or moving images obtained by an image sensor in a video call mode or capture mode. The processed image frames may be displayed through the display unit 160.

The microphone receives external audio signals in a call mode or recording mode, a voice recognition mode, or the like to process them as electrical voice data. The processed voice data may be converted and output into a format that is transmittable to a mobile communication base station through a mobile communication module in case of the call mode.

According to an embodiment disclosed in the present disclosure, the microphone may receive voice from a user when the terminal 100 is operated in a lock state.

The communication unit 120 may include a mobile communication module 121, a wireless Internet module 122, and a location information module 123.

The mobile communication module 121 may transmit and/or receive wireless signals to and/or from at least one of a base station, an external terminal and a server on a mobile communication network. The wireless signals may include various forms of data according to voice call signals, video communication call signals or text/multimedia message transmission and reception.

The wireless Internet module 122 refers to a module for wireless Internet access, and may be embedded in or externally located with respect to the terminal 100. For wireless Internet technologies, Wireless LAN (WLAN)(Wi-Fi), Wireless broadband (Wibro), World Interoperability for Microwave Access (Wimax), High Speed Downlink Packet Access (HSDPA), and the like may be used.

According to an embodiment disclosed in the present disclosure, the wireless Internet module 122 may transmit the operational status information (for example, a theft state) of the terminal 100 or the current status information of the terminal 100, and the like to another terminal, a server of a provider who provides communication services, and the like.

The location information module 123 as a module for acquiring the location of the terminal 100 may include a global positioning system (GPS) module, for example.

The location information module 123 may acquire the location of the terminal 100 while the terminal 100 is operated, and also acquire the location of the terminal 100 as needed, for example, in the event of detecting a theft according to an embodiment disclosed in the present disclosure.

The sensor unit 130 senses the movement or speed change of the terminal 100 using an acceleration sensor, a gyro sensor or the like.

The acceleration sensor is an element for converting an acceleration change in any one direction into an electrical signal. The acceleration sensor may be typically configured to mount two or three axes in one package, and according to use environments, only one axis, z-axis, may be required therefor. Accordingly, when an x-axis or y-axis directional acceleration sensor instead of a z-axis directional acceleration sensor due to some reasons, the acceleration sensor may be mounted on a main board using an additional piece board.

The gyro sensor as a sensor for measuring an angular velocity of the terminal 100 performing a rotational movement may sense a rotated angle with respect to each reference direction. For instance, the gyro sensor may sense each rotated angle with reference to three directional axes, namely, azimuth, pitch and roll.

According to an embodiment disclosed in the present disclosure, the sensor unit 130 may sense a change of the speed, acceleration or movement of the terminal 100 to determine whether or not the terminal 100 is in a theft state.

The controller 140 controls the entire operation of the terminal 100. For example, the controller 140 may perform control and processing associated with a voice call, data communication, a video call and the like.

According to an embodiment disclosed in the present disclosure, the controller 140 may perform natural language processing (NLP) to extract one or more objects contained in the user's voice received through the input unit 110. As a result of the execution of natural language processing, the controller 140 may determine whether or not the object contains an execution command of a specific function or a passphrase for releasing a lock state.

Furthermore, the controller 140 may perform various functions and services provided by the terminal 100. The function and service may be a lock function for the security of the terminal 100, and an SNS service including search or provision for information on weather, map, traffic or the like, multimedia play, voice or video call, and message transmission and reception.

According to an embodiment disclosed in the present disclosure, the controller 140 may release a lock function when the object contains a passphrase for releasing a lock state through the natural language processing. Furthermore, the controller 140 may perform the specific function when the object contains an execution command for performing a specific function.

Furthermore, the controller 140 may obtain the movement status of the terminal 100 through the sensor unit 130, and sense whether or not a theft of the terminal 100 has occurred based on this. According to a result of the sensing of whether or not the theft has occurred, the controller 140 may determine the theft status of the terminal 100 as a theft assumption state, a theft confirmation state or a theft release state, and perform the resultant additional operation.

The storage unit 150 may store a program for various operations of the terminal 100, and store input/output data (for example, phone book, messages, still images, video, etc.).

Furthermore, the storage unit 150 may store an application downloaded from an application providing server (for example, app store). The terminal 100 may provide various functions or services to a user through the application.

According to an embodiment disclosed in the present disclosure, the storage unit 150 may store one or more execution commands corresponding to various functions, events, services, and the like, respectively, provided by the terminal 100, information required for the execution of the functions, events, services, and the like or information on an object.

Furthermore, according to an embodiment disclosed in the present disclosure, the storage unit 150 may store an execution command of voice data corresponding to various functions of the terminal 100 or a passphrase set consisted of a plurality of passphrases for releasing the lock function of the terminal 100.

The storage unit 150 may include at least one type storage medium of a flash memory type, a hard disk type, a multimedia card micro type, a memory card type (e.g., SD or DX memory), Random Access Memory (RAM), Static Random Access Memory (SRAM), Read-Only Memory (ROM), Electrically Erasable Programmable Read-Only Memory (EEPROM), Programmable Read-only Memory (PROM), magnetic memory, magnetic disk, optical disk, and the like. The terminal 100 may operate in association with a web storage performing the storage function of the storage unit 150 on the Internet.

The display unit 160 displays information processed by the terminal 100 or a user interface (UI) or graphic user interface (GUI) associated therewith.

The display unit 160 may include at least one of a liquid crystal display (LCD), a thin film transistor-liquid crystal display (TFT LCD), an organic light-emitting diode (OLED) display, a flexible display, and a three-dimensional (3D) display.

Some of those displays may be configured with a transparent type or light transmissive type to allow a user to view the outside through the display unit. It may be referred to as a transparent display, and a representative example of the typical transparent display may include a transparent LCD (TOLED), and the like.

There may exist two or more display units 160 according to an implementation form of the mobile terminal 100, and a plurality of the display units 160 may be arranged on one surface to be spaced apart from or integrated with each other, or may be arranged on different surfaces.

When the display unit 160 and a touch sensitive sensor (hereinafter, referred to as a “touch sensor”) constitute an interlayer structure (hereinafter, referred to as a “touch screen”), the display unit 160 may be used as an input device rather than an output device. The touch sensor may be implemented as a touch film, a touch sheet, a touch pad, and the like, for example.

The output unit 170 may be configured to generate an output associated with visual sense, auditory sense or tactile sense, and may include an audio output module 171, an alarm unit 172, a haptic module 173, and the like.

The audio output module 171 may output audio data received from the wireless Internet module 122 or stored in the storage unit 150 in a call receiving mode, a call placing mode, a recording mode, a voice recognition mode, a broadcast reception mode, and the like. The audio output module 171 may output audio signals associated with functions (for example, sound notifying a call received, a message received, a theft alarm, etc.) performed in the terminal 100. The audio output module 171 may include a receiver, a speaker, a buzzer, and the like.

The alarm unit 172 outputs a signal notifying the occurrence of an event in the terminal 100. The examples of the event may include a call received, a message received, a key signal input, a touch input, a theft alarm and the like. The alarm unit 172 may output not only video or audio signals, but also other types of signals such as a signal notifying the occurrence of an event in a vibration manner. The video or audio signals may be also output through the display unit 160 or the audio output unit 171.

The haptic module 173 generates various tactile effects that a user can feel. A representative example of the tactile effects generated by the haptic module 173 includes vibration.

However, the constituent elements as illustrated in FIG. 1 are not necessarily required, and the mobile communication terminal may be implemented with a greater or less number of elements than those illustrated elements.

### First Embodiment

Hereinafter, the operation of a first embodiment for allowing the terminal 100 to perform the release of a lock state will be described.

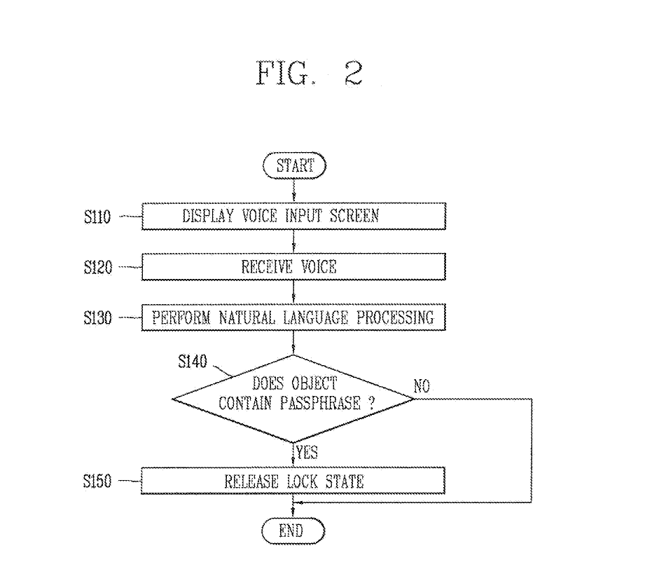

FIG. 2 is a flow chart schematically illustrating an unlock implementation method according to a first embodiment disclosed in the present disclosure.

Referring to FIG. 2, an unlock implementation method according to a first embodiment disclosed in the present disclosure may be carried out in the following sequence.

First, the terminal 100 may display a voice input screen (S110).

The terminal 100 may display the voice input screen on a lock screen.

The terminal 100 may operate in a lock state by an external input for operating the terminal 100 in a lock state or due to the passage of a predetermined period of time with no external input. When operating in a lock state, even though an input event is generated from the outside, such as a button input, a touch input, gesture recognition, voice recognition, or the like, the terminal 100 may not perform a function corresponding to the input.

When a theft state of the terminal 100 is sensed, the terminal 100 may operate in a theft state. A case where the terminal 100 operates in a lock state due to the theft state will be described in detail below with reference to a second embodiment.

When the terminal 100 operates in a lock state, the terminal 100 may display a lock screen.

The lock screen may include an icon, a lock message, a UI for entering any pattern, numeral or password input, a UI for motion recognition, a background image, and the like. The lock screen may display date, time, notification information and the like at the same time according to the type of the terminal 100, and may be displayed in the form of a screen saver, a power saving mode, or the like.

The voice input screen may be displayed on the lock screen.

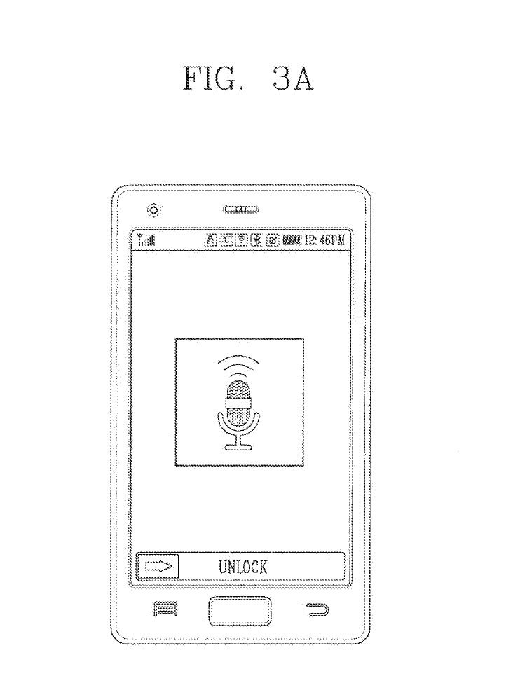

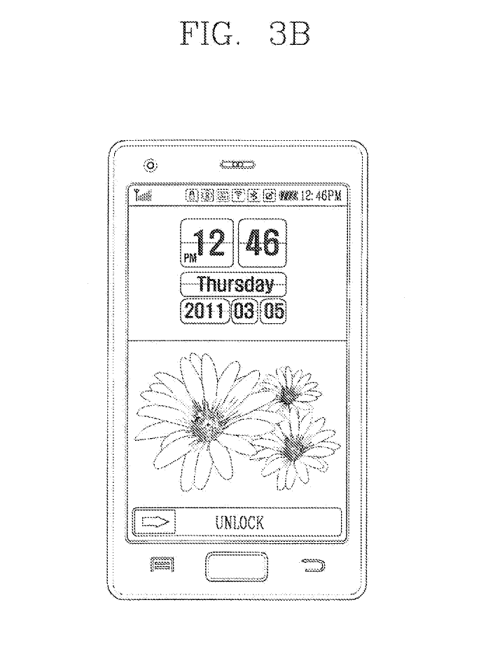

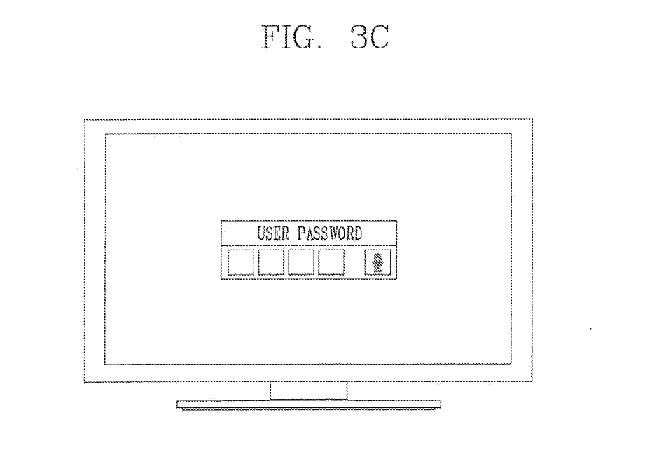

The voice input screen may include an icon, an input notification message, a UI shown on the status bar, a popup message, and the like. Otherwise, the terminal 100 may output a sound for notifying that it can recognize voice, thereby notifying a user that it is in a voice input available state. Referring to FIG. 3A, the voice input screen including a microphone shaped icon to receive voice may be displayed thereon.

The voice input screen may be displayed in a form in which the icon or UI is added to the lock screen, a form in which the screen is overlapped with the lock screen or a form in which the screen is divided from the lock screen.

Referring to FIG. 3B, the voice input screen may be displayed by adding an icon for notifying a voice input available state to the status bar on the lock screen.

Furthermore, referring to FIG. 3C, the voice input screen may be displayed in the form of an additional icon (or UI, etc.) for voice input on a password (or specific pattern) input window for unlocking on the lock screen such as a background screen, screen saver or the like.

The voice input screen may be always displayed while the terminal 100 operates in a lock state, or displayed at any time or with any time interval according to a user's voice input mode setting, power saving mode setting or the voice input period setting of the terminal 100.

Next, the terminal 100 may receive voice (S120).

The terminal 100 may receive voice from a user.

The terminal 100 may turn on the microphone at any time or with any time interval to receive the voice. For example, the terminal 100 may turn on the microphone to receive the voice while the voice input screen is displayed.

According to circumstances, when the terminal 100 does not display the voice input screen, the terminal 100 may receive the voice according to a predetermined period, a user's voice input mode setting, power saving mode setting, or the like.

While the terminal 100 operates in a lock state, the terminal 100 may maintain the microphone to be turned on to receive the voice. However, in this case, it may cause a problem such as power consumption or the like.

In addition, the terminal 100 may display or record the received voice on the screen, and then output it in the same voice format. In order to display the received voice in a text format on the screen, the terminal 100 may first perform the following natural language processing and display a text-based sentence acquired as a result of the execution on the screen.

Next, the terminal 100 may perform natural language processing (S130).

The terminal 100 may acquire an object constituting the voice in a natural language processing scheme. Here, the object constituting the voice may at least one of a sentence, a word and a vocabulary.

The natural language processing is carried out to extract an object, for example, a command, a passphrase, a name or the like contained in the voice by analyzing text data constituting the voice.

The terminal 100 may modify the lexical representation and spacing of text data constituting the voice to perform the natural language processing. For example, when text data constituting the voice is “I'm Tom, please maker called Jane”, the terminal 100 may modify the text data into “I'm Tom, please make a call to Jane”.

Furthermore, the terminal 100 may analyze the modified text data in the unit of morpheme, and then extract an object constituting each morpheme, and analyze the meaning of the text data from the extracted object. For example, if the modified text data is “I'm Tom, please make a call to Jane”, then the terminal 100 may modify it into morphemes “<I'm>+<Tom>+<please>+<make>+<a>+<call>+<to>+<Jane>”. Furthermore, objects such as “I”, “Tom”, “Jane” and “call” may be extracted from the text data that has been analyzed into morphemes, thereby analyzing that each meaning is information or an object for an execution command, a name, and function implementation, respectively.

When determined that it is a sentence similar to a sentence required for function implementation through the natural language processing even if not a correct sentence required for performing a specific function of the terminal 100, the terminal 100 may determine it as an execution command of the specific function.

In order to acquire an object from the voice as described above, the terminal 100 may store and manage one or more execution commands corresponding to various functions, events, services, and the like, respectively, provided by the terminal 100, information required for the execution of the functions, events, services, and the like or information on an object.

Next, the terminal 100 may determine whether or not the object contains a passphrase (S140).

The terminal 100 may determine whether or not a passphrase for allowing unlock is contained in one or more objects containing the voice.

The passphrase may be used to determine whether or not to allow a user who has entered the voice to release a lock state, and use a function requiring the security of the terminal 100. In other words, if the passphrase is contained in the object, then the terminal 100 may determine that the user is an owner of the terminal 100 or a user who is allowed to use a function requiring the security of the terminal 100.

At this time, even though the user does not deliberately enter voice corresponding to the passphrase, the terminal 100 may release a lock state if any one of passphrases constituting the passphrase set is contained in the object.

The passphrase may be a sentence or word constituting a passphrase set.

The passphrase set may be configured with one or more preset passphrases to authenticate a user who is allowed to release a lock state. Furthermore, the one of more passphrases constituting the passphrase set may be a sentence or word. The sentence or word may be a set of phrases repeatedly used by a user.

For example, the passphrase set may be configured with one or more passphrases such as {“I'm Tom”, “Unlock”, “Show me screen”}.

The terminal 100 may allow the release of a lock state if any one passphrase of the passphrase set configured with one or more passphrases is contained in the object. Furthermore, when the object is determined to be similar to the passphrase through natural language processing even though not the same as the passphrase, the terminal 100 may allow the release of a lock state.

For example, objects constituting the voice are “Tom”, “Jane” and “call”, the terminal 100 may allow the release of a lock state since the object contains “Tom”, and “Tom” is similar to a passphrase “I'm Tom” constituting the passphrase set.

The terminal 100 may store and manage the passphrase set, and a user may modify or edit the passphrase set according to circumstances.

Furthermore, the terminal 100 may form the passphrase set based on a result of implementing natural language processing on the voice entered by the user. Specifically, as a result of the natural language processing on the voice, the terminal 100 may analyze text data constituting the voice to calculate the use frequency of a text or word entered by the user.

Whenever entering the voice, the terminal 100 may repeatedly perform an operation for extracting a text or word entered by the user to configure the passphrase set based on texts or words having a high use frequency among texts or words constituting the entered voice. Whenever the use frequency is changed by an input of the voice, the terminal 100 may automatically update and manage the passphrase set.

The terminal 100 may allow unlock when the object contains a passphrase which is the same as or similar to the passphrase in a passphrase set configured with the one or more passphrases, thereby providing a lower level of terminal security system compared to a strict security system allowing security release only when it is the same as one passphrase.

When the object does not contain the passphrase, the terminal 100 may maintain a lock state. Otherwise, the terminal 100 may perform an additional operation based on the object or according to the need in a state that the lock state is not released.

Next, the terminal 100 may release or maintain the lock state of the terminal 100 according to a result of the determination on whether or not the object contains the passphrase.

Specifically, when the object contains the passphrase, the terminal 100 may release a lock state (S150).

The terminal 100 may release a lock state and display a background screen or the like set by the user, or perform an additional operation based on the object or according to the need as a result of the release of the lock state.

The implementation of the terminal 100 according to whether or not the object contains the passphrase will be described below in detail with reference to a first and a second embodiment.

On the contrary, when the object does not contain the passphrase, the terminal 100 may maintain the lock state.

When there exists an additionally executable operation or command while maintaining the lock state, the terminal 100 may perform the relevant operation or command.

Hereinafter, a specific operation for allowing the terminal 100 to release a lock state and additionally performing a function provided by the terminal 100 will be described in detail.

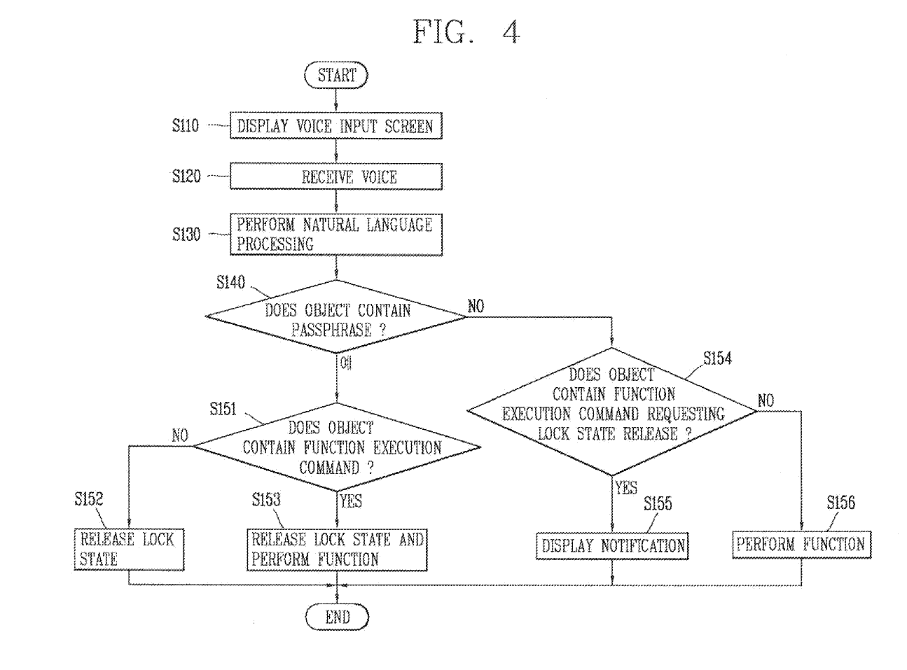

FIG. 4 is a flow chart specifically illustrating an unlock implementation method according to a first embodiment disclosed in the present disclosure.

Referring to FIG. 4, a specific unlock implementation method according to a first embodiment disclosed in the present disclosure will be carried out in the following sequence.

According to a first embodiment described with reference to FIG. 2, when the object contains a passphrase, the terminal 100 may determine whether or not the object contains a function execution command (S151).

The terminal 100 may determine whether or not an execution command for a function (or service etc.) supported by the terminal 100 is contained in one or more objects contained in the voice.

The function may include making phone calls, incoming and outgoing messages, information search, driving various applications, playing multimedia, checking information such as weather, date, time, and the like, for example. The function may be a function for requesting or not requesting lock state release.

When the object does not contain a function execution command, the terminal 100 may release a lock state (S152).

Since the object contains the passphrase, the terminal 100 may authenticate the user as a user who is allowed to use the function of the terminal 100 and release a lock state even when the object does not contain a function execution command.

Furthermore, since the object does not contain the function execution command, the terminal 100 may not perform an additional operation.

The terminal 100 may display a background screen or the like set by the user or display a screen for an operation that has been being carried out before the terminal 100 enters a lock state by the release of the lock state.

When the object contains a function execution command, the terminal 100 may release a lock state, and perform the function (S153).

Since the object contains the passphrase, the terminal 100 may authenticate the user as a user who is allowed to use the function of the terminal 100 and release a lock state.

At the same time, the terminal 100 may perform the function corresponding to the function execution command.

The terminal 100 may determine whether or not the object contains the function execution command while at the same time determining whether or not the object contains the passphrase. The terminal 100 may first whether or not containing the execution command while at the same time determining whether or not containing the passphrase, and perform an operation according to whether or not containing the execution command while at the same time performing an unlock operation.

When additional information or object is required to perform the function, the terminal 100 may extract the relevant information or object from the object to perform the function based on this.

For example, when objects constituting the voice are “I”, “Tom”, “Jane” and “call”, the terminal 100 may determine that the objects contain an execution command of a call function requesting unlock, and extract “Jane” located prior to the object “call” as information required for the execution of the call, thereby performing an operation of attempting a call to Jane.

The voice may include one or more function execution commands. The terminal 100 may extract additional information required to perform one or more function execution commands and the each function contained in the voice. In this case, the terminal 100 may concurrently or sequentially perform the one or more functions.

According to the need, the terminal 100 may perform the function without releasing a lock state. For example, when the function is a function capable of immediately perform the relevant function without releasing a lock state, the terminal 100 may immediately perform the function while maintaining a lock state even if the object contains the passphrase.

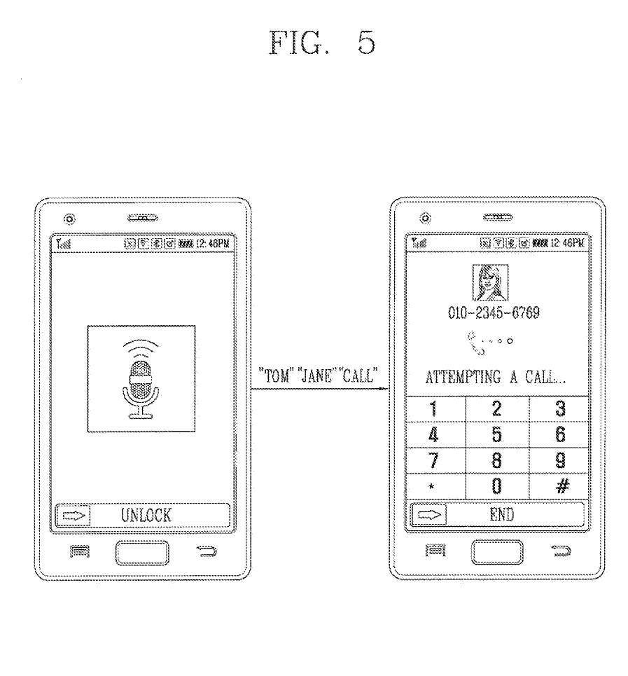

Referring to FIG. 5, when objects constituting the voice are “Tom”, “Jane” and “call”, the terminal 100 may release a lock state based on the object “Tom”, and at the same time perform an operation for attempting a call to Jane, based on the object “call” corresponding to an execution command of a phone call function for requesting the release of the lock state and the object “Jane” analyzed as an information object required to perform the call function.

As a result, an unlock implementation method disclosed in the present disclosure may perform various functions provided by the terminal 100 while at the same time performing an unlock operation through the natural language processing of the voice, thereby presenting a more convenient terminal using method performing a plurality of operations with one voice command.

Next, when the object does not contain the passphrase in a first embodiment described with reference to FIG. 2, the terminal 100 may determine whether or not the object contains a function execution command requesting lock state release (S154).

The terminal 100 may determine whether or not the execution command of a function for requesting unlock is contained in one or more objects contained in the voice.

The function for requesting unlock may include making phone calls, incoming and outgoing messages, information search, driving various applications, and the like, for example. In particular, the function for requesting unlock may be a function requiring the authentication of the user himself or herself, such as requesting information related to the user's privacy or requesting information check related to banking, mail, schedule, and phonebook among functions provided by the terminal 100.

When the object contains a function execution command for requesting the lock state release, the terminal 100 may display a notification (S155).

When the object contains an execution command of the function for requesting unlock even though unlock is not allowed since the object does not contain the passphrase, the terminal 100 may not perform the function while maintaining a lock state.

Furthermore, the terminal 100 may provide the content in which a passphrase for unlock is required to perform the function for requesting unlock to a user as a notification. The notification may be provided in various forms such as an icon, a notification message, a popup message, sound, vibration, or the like.

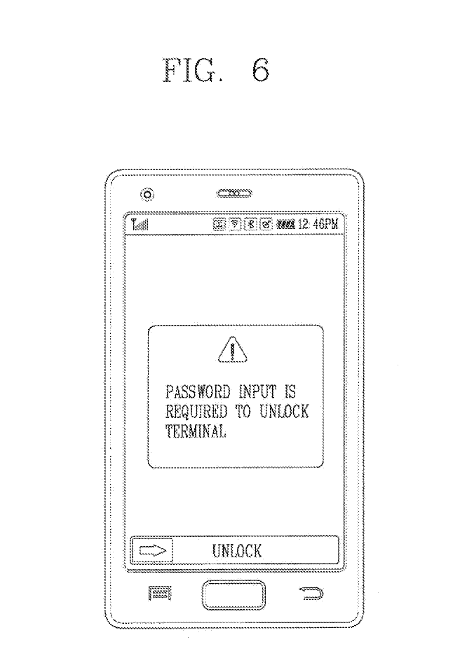

For example, referring to FIG. 6, the notification may be displayed on the lock screen as a popup window containing a message in which unlock is required.

When the object does not contain an execution command of the function for requesting unlock, namely, when the object contains an execution command of a function that does not request unlock, the terminal 100 may perform the function that does not request unlock (S156).

The function that does not request lock state release may be checking date, time, weather and the like, checking a notification message, playing music, or the like, for example. In particular, the function that does not request lock state release may be a function related to viewing information, which is not related to a user's personal information, among functions provided by the terminal 100.

When the object contains an execution command of the function that does not request unlock, the terminal 100 may perform the function without releasing a lock state.

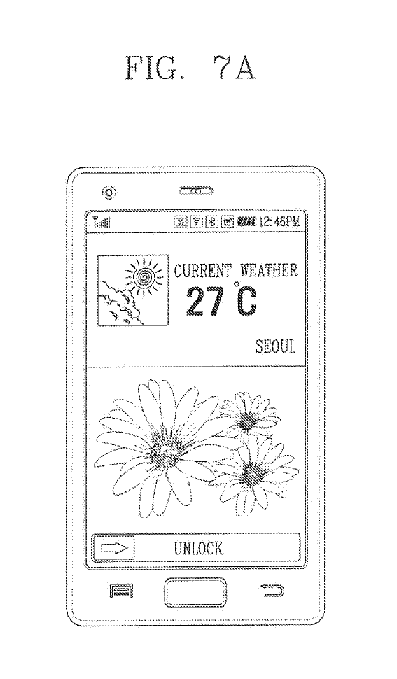

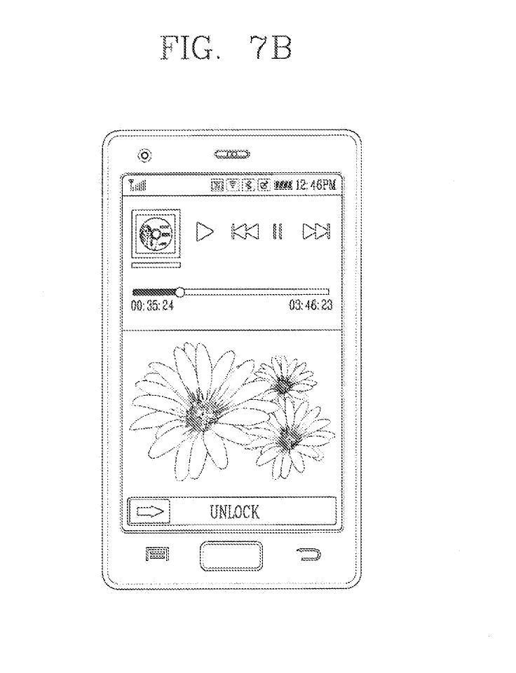

Referring to FIG. 7A, when the object contains an execution command of a music play function that does not request unlock such as “music”, “play”, “play”, “song” or the like, the terminal 100 may perform a music play function without releasing the lock state.

Furthermore, referring to FIG. 7B, when the object contains an execution command of a weather check function that does not request unlock such as “weather”, the terminal 100 perform a weather check function without releasing the lock state.

All the steps of the unlock implementation method illustrated in FIG. 4 may not be necessarily required, and therefore the omission, change or substitution of some steps thereof will be allowed within a scope that does not violate the gist of the present disclosure.

### Second Embodiment

Hereinafter, a second embodiment for releasing a lock state and allowing the terminal 100 to additionally perform a function corresponding to the event of theft when the terminal 100 senses a theft state will be described.

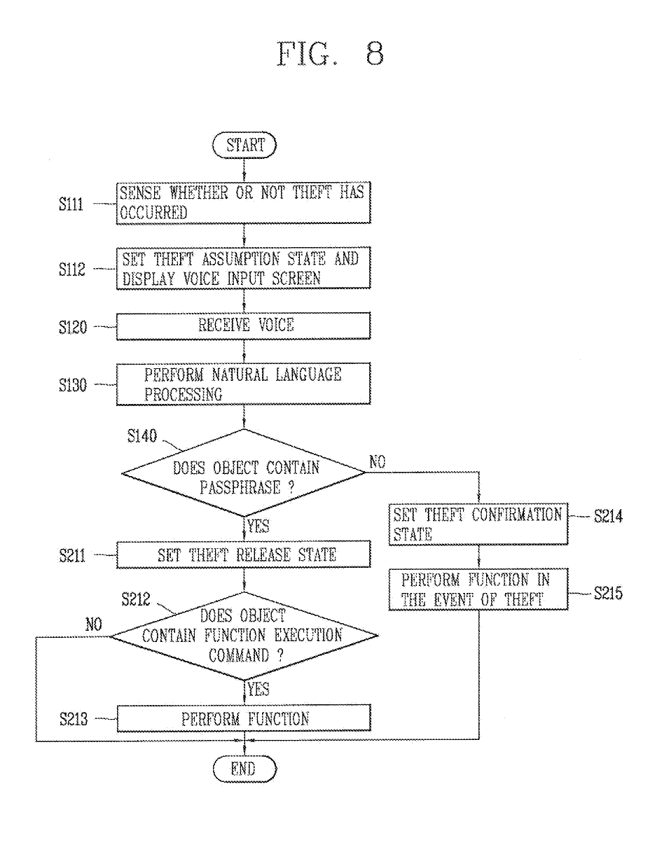

FIG. 8 is a flow chart illustrating an unlock implementation method according to a second embodiment disclosed in the present disclosure.

Referring to FIG. 8, an unlock implementation method according to a second embodiment disclosed in the present disclosure will be carried out in the following sequence.

First, the terminal 100 may sense whether or not a theft of the terminal 100 has occurred (S111).

The terminal 100 may sense whether or not the theft has occurred due to a change of the speed, acceleration or motion of the terminal 100 through the gyro sensor, the acceleration sensor, a position measurement module or the like.

The terminal 100 may set a threshold value for a change amount of the speed, acceleration or motion for sensing a theft occurrence state to store and manage the threshold value.

When the theft occurrence of the terminal 100 is sensed, the terminal 100 set the theft status of the terminal 100 to a “theft assumption state”, and display a voice input screen (S112).

For example, in case where the terminal 100 that has been no change in movement for a certain period of time abruptly increases the acceleration, or the terminal 100 moves a long distance for a short period of time, or the terminal 100 repeatedly enters wrong passwords for lock state release in a lock state, the terminal 100 may sense it as the occurrence of theft.

The terminal 100 may store and manage speed, a threshold value of acceleration change, a threshold value of time or distance change amount, a number of password inputs, and the like as a reference for determining the theft occurrence status of the terminal 100.

The terminal 100 may artificially determine that the terminal 100 is in a theft state by the user's theft status setting.

When the theft occurrence of the terminal 100 is sensed, the terminal 100 may set the theft status of the terminal 100 to a “theft assumption state”. The terminal 100 may perform an alarm warning, a password input request notification, a certain feature disable operation, or the like, for example, as an additional operation in response to the “theft assumption state”.

Furthermore, the terminal 100 may display the voice input screen. The terminal 100 may allow the terminal 100 to enter a lock state due to the occurrence of theft, and display the voice input screen on the lock screen.

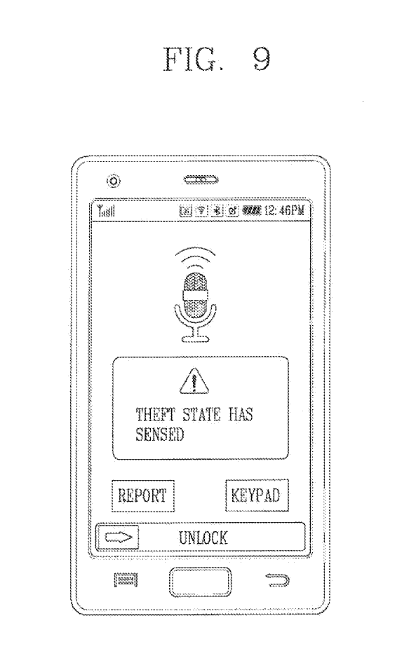

Referring to FIG. 9, the terminal 100 may display the voice input screen on the lock screen along with a warning window notifying that the terminal is in a “theft assumption state”.

Next, the terminal 100 may receive voice (S120), and perform natural language processing (S130). Furthermore, the terminal 100 may determine whether or not the object contains a passphrase (S140).

The detailed operation thereof is the same as the foregoing description according to a first embodiment.

However, when determining whether or not containing the passphrase, the terminal 100 may determine whether or not a passphrase for the release of the “theft assumption state” is contained in one or more objects contained in the voice.

The passphrase may be a sentence or word constituting a passphrase set. Here, the passphrase set may be preset to authenticate a user who is allowed to release the “theft assumption state”, and may include one or more sentence or word passphrase.

The passphrase may be the same as a passphrase for unlock disclosed in the first embodiment. In other words, when the terminal 100 enters a lock state due to sensing the theft of the terminal 100, the terminal 100 may determine that the terminal 100 is not in a theft state using a passphrase for releasing the lock state.

The terminal 100 may repeatedly receive the voice for a predetermined period of time or predetermined number of times, and determine that an object constituting the received voice contains the passphrase. In other words, the terminal 100 may not determine whether or not to release the “theft assumption state” with only a voice that has entered once, but determine whether or not the object contains the passphrase with regard to voices that have repeatedly entered for a predetermined period of time or predetermined number of times.

For example, the terminal 100 may enter a “theft assumption state” and process voices that have entered for a predetermined period of time in a natural language processing scheme to determine whether or not the object contains the passphrase. The terminal 100 may release a theft state when the passphrase is found prior to the completion of the predetermined period of time, but confirm a theft state when the passphrase is not found in voices that have entered until the completion of the predetermined period of time.

When the object contains the passphrase, the terminal 100 may set the theft status of the terminal 100 to a “theft release state” (S211).

The terminal 100 may sense that the terminal 100 is not in a theft state due to the passphrase for authenticating a user, and set the theft status to a “theft release state”.

Furthermore, the terminal 100 may display a message indicating that the theft state has been released on the screen.

In addition, the terminal 100 may determine whether or not the object contains a function execution command (S212).

The terminal 100 may determine whether or not an execution command of a function (or service etc.) supported by the terminal 100 is contained in one or more objects contained in the voice.

The function may include making phone calls, incoming and outgoing messages, information search, driving various applications, playing multimedia, checking information such as weather, date, time, and the like, for example. The function may be a function for requesting or not requesting lock state release.

When the object contains a function execution command, the terminal 100 may release a lock state, and perform the function (S213).

The terminal 100 may perform the function in various forms as illustrated in the first embodiment based on the type of the function, execution method, whether or not unlock has been requested, and the like.

When the object does not contain the passphrase, the terminal 100 may set the theft status of the terminal 100 to a “theft confirmation state” (S214).

When the object does not contain the passphrase, the terminal 100 may determine that the user of the terminal 100 is not a rightful owner, and set the theft status of the terminal 100 to a “theft confirmation state”.

Here, the terminal 100 may continuously maintain the lock state, and disallow the current user to use functions provided by the terminal 100.

In addition, the terminal 100 may perform an operation corresponding to the event of theft (S215).

The operation corresponding to the event of theft may be at least one of warning, alarm, generating vibration or the like, transmitting the current location of the terminal 100 to another terminal or a provider server who provides communication services, deleting specific information stored in the terminal 100, and theft report to a provider who provides communication services to the terminal 100 or police.

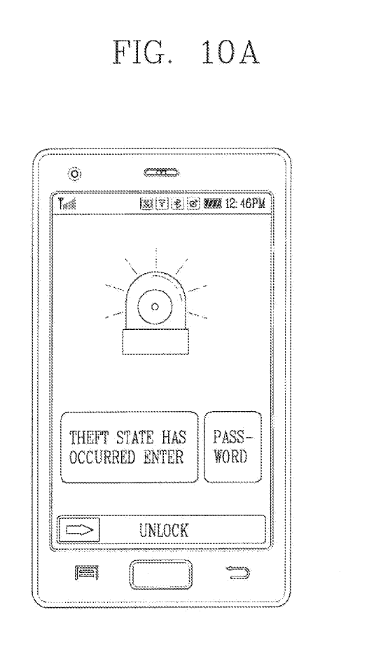

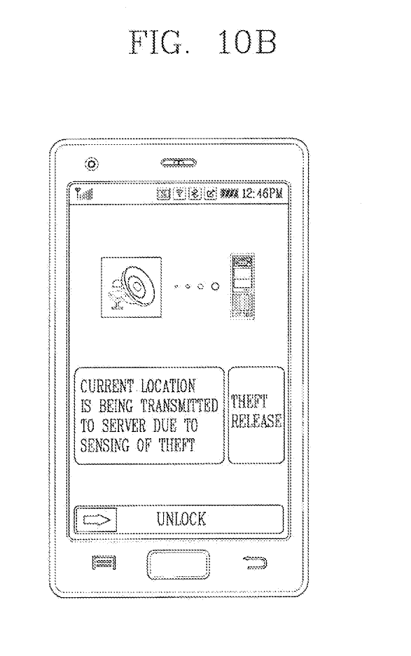

Referring to FIG. 10A, when the terminal 100 is set to a “theft confirmation state”, the terminal 100 may display an indicator indicating the occurrence of theft in the form of a warning window, a notification message, a popup window, and the like. Furthermore, the terminal 100 may output a warning sound, an alarm sound, vibration and the like. The terminal 100 may display a password input or theft release icon for allowing the user to release the theft state at the same time.

Referring to FIG. 10B, when the terminal 100 is set to a “theft confirmation state”, the terminal 100 may display a notification message indicating that the location information of the terminal 100 is transmitted to another terminal, a communication provider, or an administrator server or display a notification message for reporting the theft state of the terminal 100.

It will be apparent to those skilled in this art that various changes and modifications may be made thereto without departing from the gist of the present invention. Accordingly, it should be noted that the embodiments disclosed in the present invention are only illustrative and not limitative to the concept of the present invention, and the scope of the concept of the invention is not limited by those embodiments. The scope protected by the present invention should be construed by the accompanying claims, and the entire technical concept within the equivalent scope of the invention should be construed to be included in the scope of the right of the present invention.

1. An unlock implementation method of a terminal providing a lock function, the method comprising:
displaying a voice input screen on a lock screen of the terminal;
receiving voice from a user;
processing the voice in a natural language processing scheme to acquire an object constituting the voice;
determining whether or not the object contains a passphrase for releasing a lock state; and
releasing or maintaining the lock state of the terminal according to the determination result on whether or not the object contains the passphrase.

2. The method of claim 1, wherein the object constituting the voice is at least one of a sentence, a word and a vocabulary.

3. The method of claim 1, wherein the passphrase is a sentence or word which is the same as or similar to any one of one or more passphrases constituting a passphrase set,
wherein the passphrase set comprises at least one passphrase which is preset to authenticate a user who is allowed to release a lock state.

4. The method of claim 1, wherein said releasing or maintaining a lock state comprises:
determining whether or not the object contains an execution command of a function provided by the terminal when the object contains the passphrase; and
releasing the lock state and performing the function when containing the execution command, and releasing the lock state when not containing the execution command.

5. The method of claim 1, wherein said releasing or maintaining the lock state comprises:
determining whether or not the object contains an execution command of a function that does not require the release of the lock state when the object does not contain the passphrase; and
performing the function without releasing the lock state based on a result of the determination on whether or not containing the execution command.

6. The method of claim 1, wherein said displaying a voice input screen comprises:
sensing whether or not a theft of the terminal has occurred; and
setting a theft status of the terminal to a theft assumption state based on the sensing result, and displaying the voice input screen on the lock screen.

7. The method of claim 6, wherein said releasing or maintaining the lock state of the terminal comprises:
releasing the lock state and setting the theft status to a theft release state when the object contains the passphrase, and setting the theft status to a theft confirmation state without releasing the lock state when the object does not contain the passphrase.

8. The method of claim 7, further comprising:
performing at least one of the operations of alarm warning, transmitting a current location of the terminal to another terminal, deleting specific information stored in the terminal, and theft report when the object does not contain the passphrase.

9. A terminal providing a lock function, the terminal comprising:
a display unit configured to display a voice input screen on a lock screen of the terminal;
an input unit configured to receive voice from a user; and
a controller configured to process the voice in a natural language processing scheme to acquire an object constituting the voice,
wherein the controller determines whether or not the object contains a passphrase for releasing a lock state, and releases or maintains the lock state of the terminal according to the determination result on whether or not the object contains the passphrase.

10. The terminal of claim 9, wherein the object constituting the voice is at least one of a sentence, a word and a vocabulary.

11. The terminal of claim 9, further comprising:
a storage unit configured to store a passphrase set comprising at least one passphrase which is preset to authenticate a user who is allowed to release a lock state,
wherein the passphrase is a sentence or word which is the same as or similar to any one of one or more passphrases constituting the passphrase set.

12. The terminal of claim 9, wherein the controller determines whether or not the object contains an execution command of a function provided by the terminal when the object contains the passphrase, and releases a lock state and performs the function when containing the execution command, and releases the lock state when not containing the execution command.

13. The terminal of claim 9, wherein the controller determines whether or not the object contains an execution command of a function that does not require the release of the lock state when the object does not contain the passphrase, and performs the function without releasing the lock state based on a result of the determination on whether or not containing the execution command.

14. The terminal of claim 9, further comprising:
a senor unit configured to sense whether or not a theft of the terminal has occurred,
wherein the controller sets a theft status of the terminal to a theft assumption state based on the sensing result of the sensor unit, and controls the display unit to display the voice input screen on the lock screen.

15. The terminal of claim 14, wherein the controller releases a lock state and sets the theft status to a theft release state when the object contains the passphrase, and sets the theft status to a theft confirmation state without releasing the lock state when the object does not contain the passphrase.

16. The terminal of claim 15, wherein the controller performs at least one of the operations of alarm warning, transmitting a current location of the terminal to another terminal, deleting specific information stored in the terminal, and theft report when the object does not contain the passphrase.
